(19) United States
(12) Patent Application Publication
(10) Pub. No.: US 2011/0258814 A1
(43) Pub. Date: Oct. 27, 2011

(54) Cord Runner for Panel Track Window Coverings

(76) Inventor: Philip Ng, Thornhill (CA)

(21) Appl. No.: 12/633,052

(22) Filed: Dec. 8, 2009

(51) Int. Cl. F16G 11/00

(52) U.S. Cl. 24/115 R

(57) ABSTRACT

The present invention is an improved cord runner for use with a track of a panel track window covering. The track which is used with the cord runner has a first and a second channel separated by a wall having an elongated groove separating the first and second channels. The cord runner includes a body having opposite first and second ends, opposite first and second sides, a top and a bottom, the body being dimensioned to fit within the first channel. The cord runner further includes a pair of side guides formed on the first side of the body, said pair of side guides having a T shaped profile, said pair of side guides being dimensioned to extend through the groove and into the second channel.

### FIELD OF THE INVENTION

The invention relates generally to cord runners for use with panel track window coverings.

### BACKGROUND OF THE INVENTION

Panel type window coverings often utilize an elongated track from which the panels are hung. In order to draw the window coverings open or closed, the panels are made to slide along the track by means of chords. To ensure that the panels can be moved, a chord runner is attached to an elongated chord, and the chord runner is in turn retained within the track. Pulling on the chord causes the runner to be pulled along the track which in turn causes the panel to slide along the track. This system is quite effective; however, it is occasionally prone to jamming. As the chord is pulled tightly, the runner attached to the chord may lose coaxial alignment with the track, causing it to jam in the track. An improved chord runner which overcomes the difficulties of this problem is therefore required.

### SUMMARY OF THE INVENTION

In accordance with one aspect of the present invention, there is provided an improved cord runner for use with a track of a panel track window covering, the cord runner being resistant to jamming. The cord runner includes a body having opposite first and second ends, opposite first and second sides, a top and a bottom. A pair of side guides are formed on the first side of the body, said pair of side guides having a T shaped profile.

In accordance with another aspect of the present invention, there is provided an improved cord runner for use with a track of a panel track window covering, the track having a first and a second channel separated by a wall having an elongated groove. The cord runner includes a body having opposite first and second ends, opposite first and second sides, a top and a bottom, the body being dimensioned to fit within the first channel. The cord runner further includes a pair of side guides formed on the first side of the body, said pair of side guides having a T shaped profile, said pair of side guides being dimensioned to extend through the groove and into the second channel.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a cross sectional view of a panel track as used in a panel track window covering.

FIG. 2 is a perspective view of a cord runner made in accordance with the present invention for use with the panel track shown in FIG. 1.

FIG. 3 is a cross sectional view of a cord runner shown in FIG. 2 contained within the panel track shown in FIG. 1.

FIG. 4 is a perspective view of a cord runner made in accordance with the present invention and installed for use in the panel track shown in FIG. 1.

FIG. 5 is a side view of the cord runner shown in FIG. 2 showing a cord attached to the cord runner.

In the drawings like characters of reference indicate corresponding parts in the different figures.

### DETAILED DESCRIPTION OF THE INVENTION

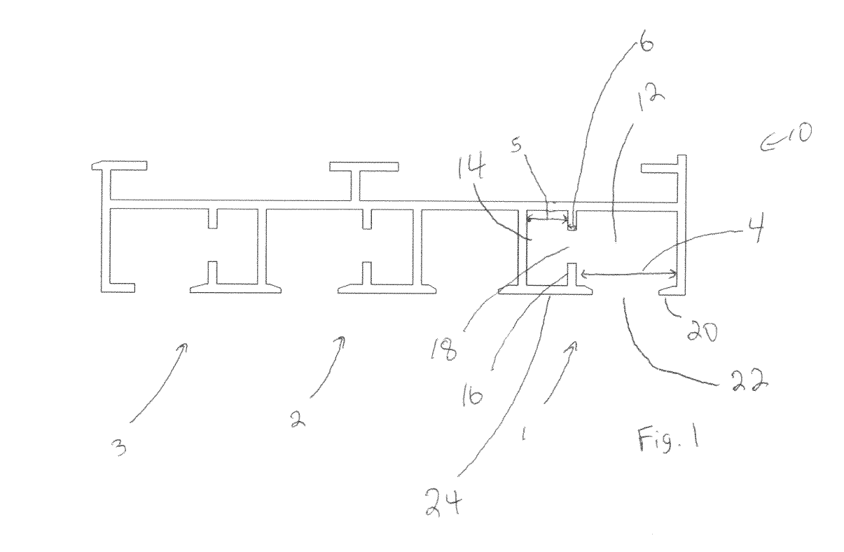

Referring to FIG. 1 a panel track as generally used with panel track window coverings is shown generally as item 10 and consists of an aluminum extrusion having a number of separate tracks formed therein. In the present example, three separate tracks are formed in panel track extrusion 10, namely tracks 1, 2 and 3. Each of the tracks are identical; however, for the purposes of this discussion, only track 1 will be discussed. Track 1 consists of two channels, 12 and 14 separated by wall 16 having elongated groove 18. Groove 18 extends the entire length of the panel track. Channel 12 is partially enclosed by wall 20 having elongated groove 22 while channel 14 is closed off by wall 24. Channel 12 has a height 4, wall 16 has a thickness 6 and channel 14 has a height 5.

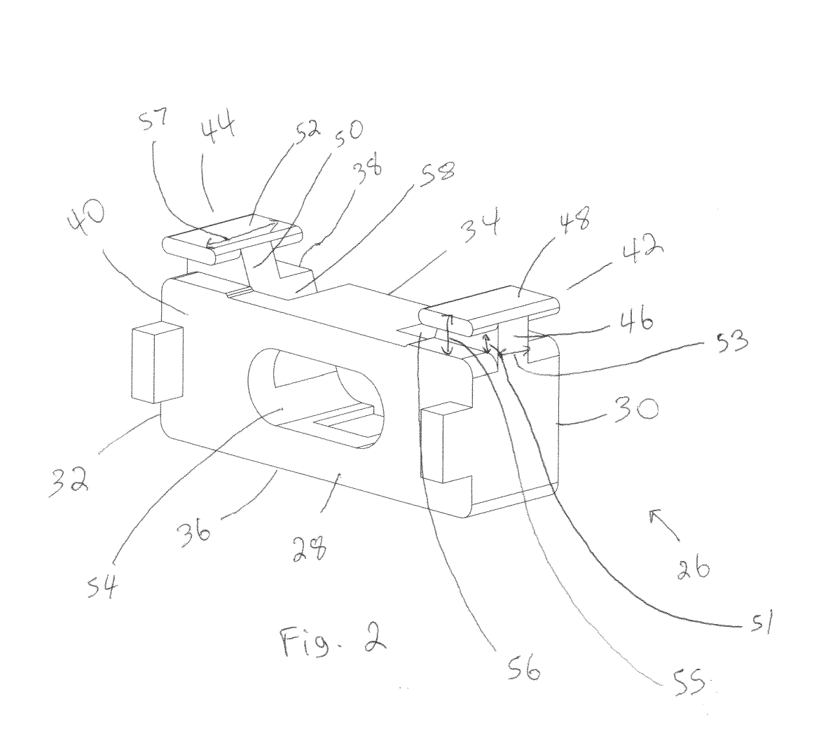

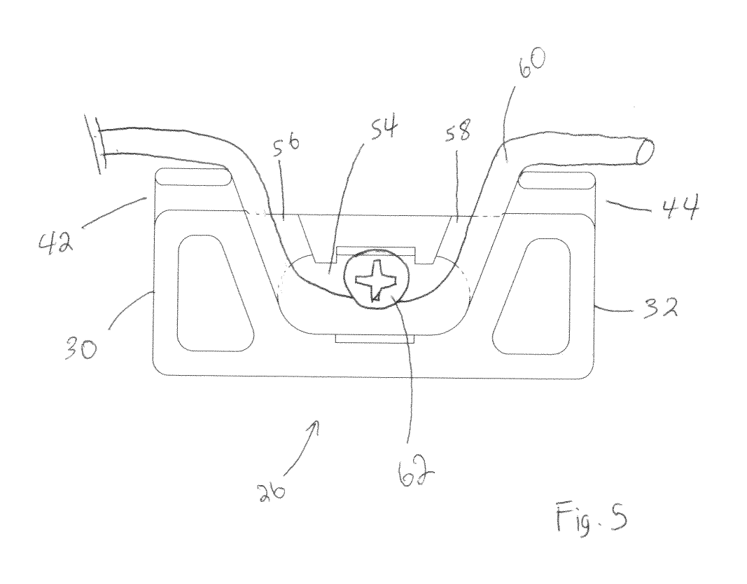

Referring now to FIG. 2, a cord runner made in accordance with the present invention is shown generally as item 26 and includes a generally rectangular body 28 having opposite ends 30 and 32, a pair of opposite sides 34 and 36 and opposite sides 38 and 40. Cord runner 26 is preferably made of a strong plastic which preferably has a smooth low friction surface. Plastics such as Teflon™ are suitable for use in constructing the cord runner. Guides 42 and 44 project from side 34 adjacent ends 30 and 32, respectively. Guide 42 has a T shaped profile consisting of web portion 46 and transverse portion 48. Likewise, guide 44 has a T shaped profile consisting of web portion 50 and transverse portion 52. Each of the guides has an identical height 55 and width 57. The webs each have a thickness 53 and a length 51. The length 51 of the webs is slightly larger than the thickness of 6 of wall 16 (see FIG. 1) and the height 55 of the height 55 and width 57 of each guide is dimensioned to fit snuggly within channel 14 (see FIG. 1). Aperture 54 is formed in body 28 which passes through sides 38 and 40. Side openings 56 and 58 communicate with aperture 54, as better seen in FIG. 5.

Referring to FIG. 5, cord runner 26 is configured to accept a cord 60 for pulling the cord runner through the track. Cord 60 is attached by passing the cord through side opening 56, aperture 54 and side opening 58. Cord 60 is then held in place by driving screw 62 into opening 54. In this way, cord 60 can be quickly and securely fixed to cord runner 26.

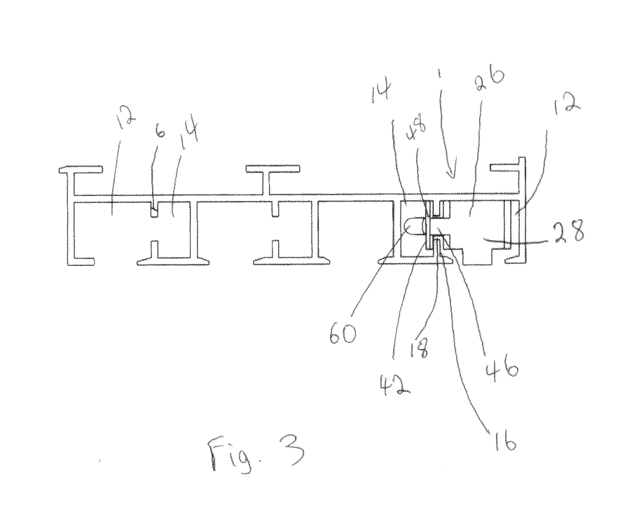

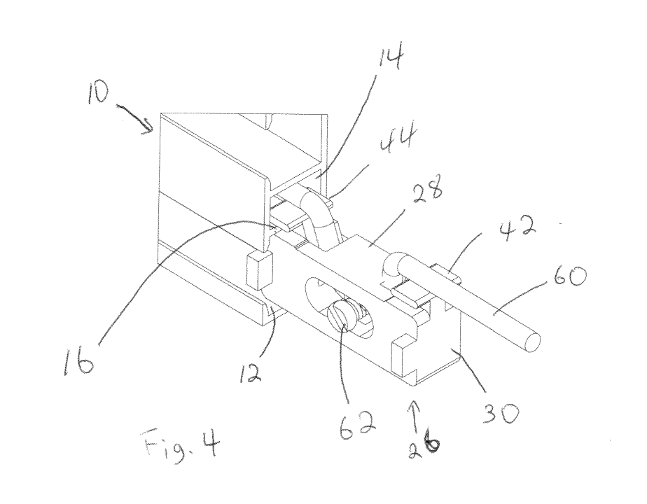

Referring now to FIG. 3, the rectangular body 28 of cord runner 26 is dimensioned to fit within channel 12 and the projecting from the side of body 28 (only guide 42 is shown in this view) project through slot 18 and into channel 14. The web portions of the guides are dimensioned to be slightly narrower than slot 18 to permit the web to fit snuggly within the slot. The height of the webs are slightly larger than the thickness of wall 16. The transverse portions are dimensioned to fit snugly within channel 14. As best seen in FIG. 4, the height of the guides 42 and 44 and the dimensions of channel 14 are dimensioned to accommodate cord 60 with the guides fitting snuggly within the channel. The T-shaped profile of the guides prevents cord runner from becoming jammed in channel 12 as cord 60 is pulled by ensuring that the cord runner remains coaxially aligned with the channel. The coaxial alignment is maintained even when a large force is exerted onto cord 60 because the T-shaped profile of the guides is configured to hold wall 16 closely. Furthermore, the guides, being positioned on the opposite sides of the cord runner, help to keep the cord runner coaxially aligned with the channel.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A cord runner for use with a track of a panel track window covering, the cord runner comprising:
a. A body having opposite first and second ends, opposite first and second sides, a top and a bottom;
b. A pair of side guides formed on the first side of the body, said pair of side guides having a T shaped profile.

2. A chord runner for use with a track of a panel track window covering, track having a first and second channel separated by a wall having an elongated groove, the chord runner comprising:
a. a body having opposite first and second ends, opposite first and second sides, a top and a bottom, the body being dimensioned to fit within the first channel;
b. a pair of side guides formed on the first side of the body, said pair of side guides having a T shaped profile, said pair of side guides being dimensioned to extend through the groove and into the second channel.

3. The chord runner as defined in claim 2 wherein the chord runner further comprises a central aperture formed on the body and a side opening formed on the first side, said side opening communicating with the central aperture.

4. The chord runner as defined in claim 3 wherein the side opening is dimensioned to permit a chord attached to the chord runner to pass there through.

5. The chord runner as defined in claim 2 wherein the side guides are positioned adjacent the first and second opposite ends of the body.

6. The chord runner as defined in claim 5 wherein the side guides have a height, the height of the side guides being slightly less than a height of the second channel.

7. The chord runner as defined in claim 6 wherein the side guides have a central web, the central web being dimensioned to be slightly narrower than a width of the groove.

8. The chord runner as defined in claim 7 wherein the central web has a length slightly greater than a thickness of the wall.

9. The chord runner as defined in claim 1 wherein the chord runner further comprises a central aperture formed on the body and a side opening formed on the first side, said side opening communicating with the central aperture.

10. The chord runner as defined in claim 9 wherein the side opening is dimensioned to permit a chord attached to the chord runner to pass there through.

11. The chord runner as defined in claim 1 wherein the side guides are positioned adjacent the first and second opposite ends of the body.

12. The chord runner as defined in claim 11 wherein the side guides have a height, the height of the side guides being slightly less than a height of the second channel.

13. The chord runner as defined in claim 12 wherein the side guides have a central web, the central web being dimensioned to be slightly narrower than a width of the groove.

14. The chord runner as defined in claim 13 wherein the central web has a length slightly greater than a thickness of the wall.
